(19) United States
(12) Patent Application Publication
(10) Pub. No.: US 2014/0176707 A1
(43) Pub. Date: Jun. 26, 2014

(54) Determining The Position Of A Consumer In A Retail Store Using A Light Source

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/723,003

(22) Filed: Dec. 20, 2012

(51) Int. Cl. H04N 7/18

(52) U.S. Cl. CPC H04N 7/18
USPC 348/143

(57) ABSTRACT

A computer-implemented method is disclosed herein. The method includes the step of positioning at least one light source at a position in a retail store. The method also includes the step of receiving, with a processing device of a position detection server, a video signal from an electronic device possessed by a consumer as the consumer shops in the retail store. At least one image frame of the video signal contains the at least one light source. The method also includes the step of determining, with the processing device, a location of the consumer within the retail store in response to the receiving step.

### BACKGROUND INFORMATION

1. Field of the Disclosure

The present invention relates generally to determining the position of a consumer within a retail store based on a video signal containing images of a light source within the store.

2. Background

Manufacturers expend significant resources to better understand consumer purchasing habits in order to more effectively market products to consumers. The movement of consumers within a retail store can provide opportunities for marketing products to consumers. For example, if it were known that a consumer was moving toward a particular product, information and promotions associated with that product could be provided to the consumer. However, a retail store may extend across a large area and the retail store may offer thousands of different products for sale. It is not feasible to bombard a consumer regarding all of the available products, nor is it feasible to request that the consumer advise the retail store of the consumer's expected path of movement.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is an example schematic illustrating a system according to some embodiments of the present disclosure.

FIG. 2 is an example block diagram illustrating an augmented reality device unit that can be applied in some embodiments of the present disclosure.

FIG. 3 is an example block diagram illustrating a position detection server that can be applied in some embodiments of the present disclosure.

FIG. 4A is an example of a retail store layout map with light sources placed throughout that can be applied in some embodiments of the present disclosure.

FIG. 4B is an example of a retail store shelf with a plurality of light sources that can be applied in some embodiments of the present disclosure.

FIG. 4C is a set of different light source examples that can be applied in some embodiments of the present disclosure.

FIG. 5 is an example flow chart illustrating a method that can be carried out according to some embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present disclosure. It will be apparent, however, to one having ordinary skill in the art that the specific detail need not be employed to practice the present disclosure. In other instances, well-known materials or methods have not been described in detail in order to avoid obscuring the present disclosure.

Reference throughout this specification to “one embodiment”, “an embodiment”, “one example” or “an example” means that a particular feature, structure or characteristic described in connection with the embodiment or example is included in at least one embodiment of the present disclosure. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present disclosure may take the form of a computer program product embodied in any tangible medium of expression having computer-usable program code embodied in the medium.

Embodiments of the present disclosure can assist in determining the location of a consumer in a retail store. When the location of the consumer has been determined, information related to products that are proximate to the consumer can be transmitted to the consumer. A system according to some embodiments of the disclosure can include a position detection server that receives a video signal from an electronic device possessed by a consumer, such as an augmented reality device. The augmented reality device can be a head mountable unit worn by the consumer. This video signal can include at least one image frame in which one or more light sources are visible. A light source includes at least one light-emitting structure. A light-emitting structure can be a candescent light, a light emitting diode, a fluorescent light, or any other structure operable to emit light. A light source can include more than one light-emitting structure. In some embodiments of the present disclosure, a plurality of light sources can be positioned in spaced locations about a retail store.

The video signal approximates the view of the consumer. The position detection server can determine the direction in which the consumer is looking and the location of the consumer within the retail store based on the identity of the light source in the video signal and the position of that light source within the retail store.

In some embodiments of the present disclosure, a light source can include a single light-emitting structure or can include multiple light-emitting structures positioned together as a group. A group of light-emitting structures can be arranged in a pattern, such as a strip or an array. A pattern for a group of light-emitting structures can be selected based on numerous considerations, such as the physical size of the light-emitting structures, the frequency spectrum emitted by the light-emitting structures, and/or the flashing frequency of the light-emitting structures. The pattern of the group of light-emitting structures can be detected by the position detection server. The position detection server can identify a light source from other light sources in the retail store in response to the pattern of light-emitting structures that are detected in a video signal.

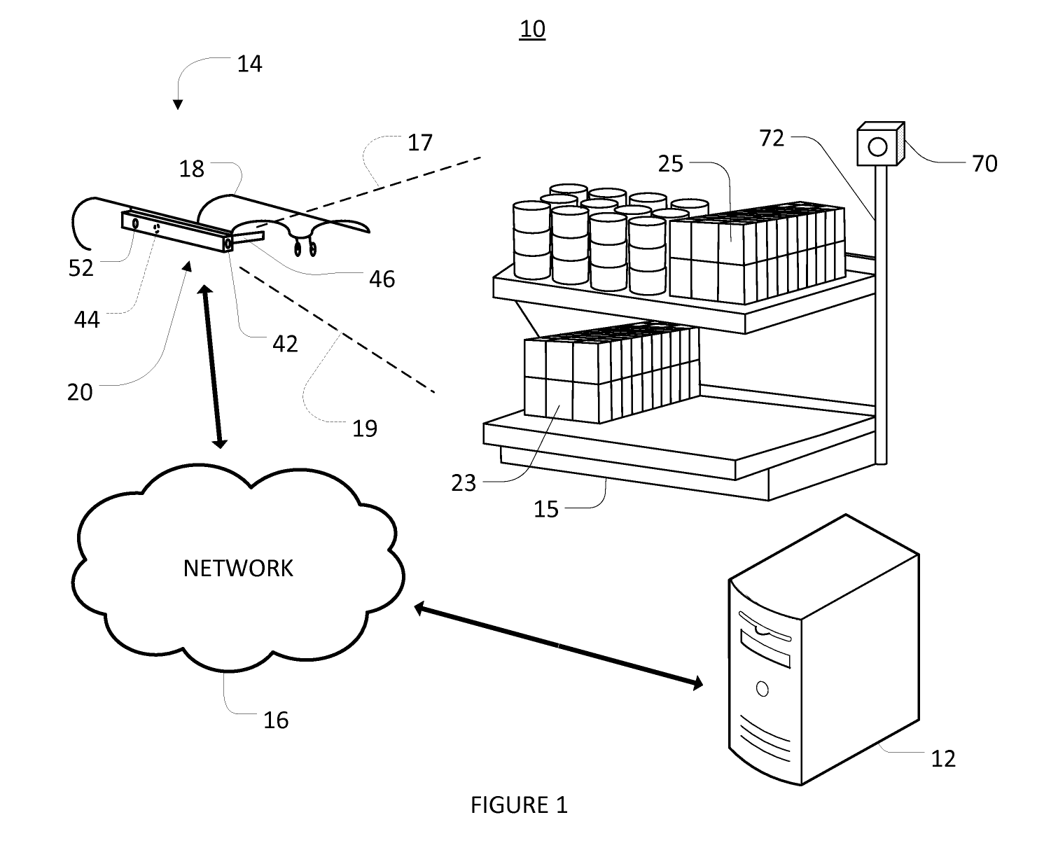

FIG. 1 is a schematic illustrating a video monitoring system 10 according to some embodiments of the present disclosure. The video monitoring system 10 can implement a computer-implemented method that includes the step of receiving, with a position detection server 12, video from an augmented reality device worn by a consumer as the consumer is traversing through a retail store. The video can be received as a video signal from an augmented reality device such as a head mountable unit 14. The head mountable unit 14 can be worn by a consumer while shopping within a retail store. In the illustrated embodiment of FIG. 1, the exemplary head mountable unit 14 includes a frame 18 and a communications unit 20 supported on the frame 18.

A video signal can be transmitted from the head mountable unit 14 in which a portion of store shelving 15 is in the field of view of a camera 42 of the head mountable unit 14. A light source 70 can be attached to the shelving 15 through an attaching structure 72. It is noted that embodiments of the present disclosure can be practiced in retail stores not using shelving and in retail stores partially using shelving.

The field of view of a camera 42 is illustrated schematically by dashed lines 17 and 19. The dashed lines 17 and 19 represent edges of the field of view of the camera 42. One or more products, such as products 23 and 25, can be disposed on the shelving 15 within the field of view of the camera 42.

The one or more signals transmitted by the head mountable unit 14 and received by the position detection server 12 can be transmitted through a network 16. As used herein, the term “network” can include, but is not limited to, a Local Area Network (LAN), a Metropolitan Area Network (MAN), a Wide Area Network (WAN), the Internet, or combinations thereof. Embodiments of the present disclosure can be practiced with a wireless network, a hard-wired network, or any combination thereof.

The light source 70 can be controlled to pulsate. The timing pattern of various light sources positioned within the retail store can be different from one another in order to differentiate the light sources from each other. In some embodiments of the present disclosure, the light source 70 can include a local controller such as a pulsation module that directs the pulsation of the light source 70. In FIG. 1, a pulsation module can be positioned internally of the light source 70 and therefore not visible.

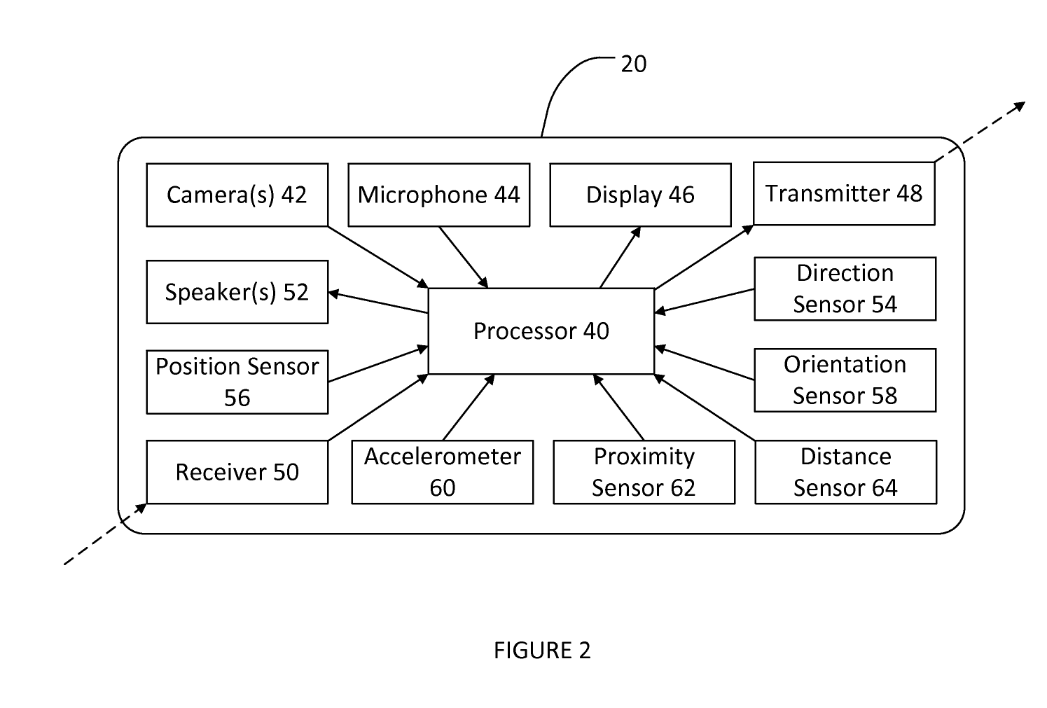

FIG. 2 is a block diagram illustrating exemplary components of the communications unit 20. The communications unit 20 can include a processor 40, one or more cameras 42, a microphone 44, a display 46, a transmitter 48, a receiver 50, one or more speakers 52, a direction sensor 54, a position sensor 56, an orientation sensor 58, an accelerometer 60, a proximity sensor 62, and a distance sensor 64.

The processor 40 can be operable to receive signals generated by the other components of the communications unit 20. The processor 40 can also be operable to control the other components of the communications unit 20. The processor 40 can also be operable to process signals received by the head mount unit 14. While one processor 40 is illustrated, it should be appreciated that the term “processor” can include two or more processors that operate in an individual or distributed manner.

The head mount unit 14 can include one or more cameras 42. Each camera 42 can be configured to generate a video signal. One of the cameras 42 can be oriented to generate a video signal that approximates the field of view of the consumer wearing the head mountable unit 14. Each camera 42 can be operable to capture single images and/or video and to generate a video signal based thereon. The video signal may be representative of the field of view of the consumer wearing the head mountable unit 14.

In some embodiments of the disclosure, the head mountable unit 14 can include a plurality of forward-facing cameras 42. The cameras 42 can define a stereo camera with two or more lenses, each with a separate image sensor. This arrangement allows the cameras 42 to simulate human binocular vision and thus capture three-dimensional images. This process is known as stereo photography. The cameras 42 can also be configured to execute computer stereo vision in which three-dimensional information is extracted from digital images. In such embodiments, the orientation of the cameras 42 can be known and the respective video signals can be processed to triangulate an object such as the light source 70 with both video signals. This processing can be applied to determine the distance that the consumer is spaced from the light source 70. Determining the distance that the consumer is spaced from the light source 70 can be executed by the processor 40 or by the position detection server 12 using known distance calculation techniques.

Processing of the one or more, forward-facing video signals can also be applied to determine the identity of the light source 70 relative to other light sources in the retail store. The processor 40 can modify the video signals to limit the transmission of data back to the position detection server 12. For example, the video signal can be parsed and one or more image files can be transmitted to the position detection server 12 instead of a live video feed. Further, the video can be modified from color to black and white to further reduce transmission load and/or ease the burden of processing for either the processor 40 or the position detection server 12. Also, the video can cropped to an area of interest to reduce the transmission of data to the position detection server 12. Video processing might drain batteries of the head mountable unit 14, so in some embodiments processing could be done periodically, such as every 15 seconds.

In some embodiments of the present disclosure, the cameras 42 can include one or more inwardly-facing camera 42 directed toward the consumer's eyes. A video signal revealing the consumer's eyes can be processed using eye tracking techniques to determine the direction that the consumer is viewing. In one example, a video signal from an inwardly-facing camera can be correlated with one or more forward-facing video signals to determine the light source that the consumer is viewing.

The microphone 44 can be configured to generate an audio signal that corresponds to sound generated by and/or proximate to the consumer. The audio signal can be processed by the processor 40 or by the position detection server 12. For example, verbal signals can be processed by the position detection server 12 such as “this product appears interesting.” Such audio signals can be correlated to a video recording.

The display 46 can be positioned within the consumer's field of view. Video content can be shown to the consumer with the display 46. The display 46 can be configured to display text, graphics, images, illustrations and any other video signals to the consumer. The display 46 can be transparent when not in use and partially transparent when in use to minimize the obstruction of the consumer's field of view through the display 46.

The transmitter 48 can be configured to transmit signals generated by the other components of the communications unit 20 from the head mountable unit 14. The processor 40 can direct signals generated by components of the communications unit 20 to the commerce sever 12 through the transmitter 48. The transmitter 48 can be an electrical communication element within the processor 40. In one example, the processor 40 is operable to direct the video and audio signals to the transmitter 48 and the transmitter 48 is operable to transmit the video signal and/or audio signal from the head mountable unit 14, such as to the position detection server 12 through the network 16.

The receiver 50 can be configured to receive signals and direct signals that are received to the processor 40 for further processing. The receiver 50 can be operable to receive transmissions from the network 16 and then communicate the transmissions to the processor 40. The receiver 50 can be an electrical communication element within the processor 40. In some embodiments of the present disclosure, the receiver 50 and the transmitter 48 can be an integral unit.

The transmitter 48 and receiver 50 can communicate over a Wi-Fi network, allowing the head mountable device 14 to exchange data wirelessly (using radio waves) over a computer network, including high-speed Internet connections. The transmitter 48 and receiver 50 can also apply Bluetooth® or Zigbee® standards for exchanging data over short distances by using short-wavelength radio transmissions, and thus creating a personal area network (PAN). The transmitter 48 and receiver 50 can also apply 3G or 4G, which is defined by the International Mobile Telecommunications-2000 (IMT-2000) specifications promulgated by the International Telecommunication Union. The transmitter 48 and the receiver 50 can also apply a combination of wireless connections using differing technologies simultaneously.

The head mountable unit 14 can include one or more speakers 52. Each speaker 52 can be configured to emit sounds, messages, information, and any other audio signal to the consumer. The speaker 52 can be positioned within the consumer's range of hearing. Audio content transmitted by the position detection server 12 can be played for the consumer through the speaker 52. The receiver 50 can receive the audio signal from the position detection server 12 and direct the audio signal to the processor 40. The processor 40 can then control the speaker 52 to emit the audio content.

The direction sensor 54 can be configured to generate a direction signal that is indicative of the direction that the consumer is looking. The direction signal can be processed by the processor 40 or by the position detection server 12. For example, the direction sensor 54 can electrically communicate the direction signal containing direction data to the processor 40 and the processor 40 can control the transmitter 48 to transmit the direction signal to the position detection server 12 through the network 16. By way of example and not limitation, the direction signal can be useful in determining the identity of a light source 70 in the video signal, as well as the location of the consumer within the retail store.

The direction sensor 54 can include a compass or another structure for deriving direction data. For example, the direction sensor 54 can include one or more Hall effect sensors. A Hall effect sensor is a transducer that varies its output voltage in response to a magnetic field. For example, the sensor operates as an analog transducer, directly returning a voltage. With a known magnetic field, its distance from the Hall plate can be determined. Using a group of sensors disposing about a periphery of a rotatable magnetic needle, the relative position of one end of the needle about the periphery can be deduced. It is noted that Hall effect sensors can be applied in other sensors of the head mountable unit 14.

The position sensor 56 can be configured to generate a position signal indicative of the position of the consumer within the retail store. The position sensor 56 can be configured to detect an absolute or relative position of the consumer wearing the head mountable unit 14. The position sensor 56 can electrically communicate a position signal containing position data to the processor 40 and the processor 40 can control the transmitter 48 to transmit the position signal to the position detection server 12 through the network 16. This position signal can, in combination with the present disclosure, result in a more accurate determination of the consumer's location within the store.

Identifying the position of the consumer can be accomplished by radio, ultrasound or ultrasonic, infrared, or any combination thereof. The position sensor 56 can be a component of a real-time locating system (RTLS), which is used to identify the location of objects and people in real time within a building such as a retail store. The position sensor 56 can include a tag that communicates with fixed reference points in the retail store. The fixed reference points can receive wireless signals from the position sensor 56. The position signal can be processed to assist in identifying one or more light sources 70 that are proximate to the consumer and are visible in the video signal.

The orientation sensor 58 can be configured to generate an orientation signal indicative of the orientation of the consumer's head, such as the extent to which the consumer is looking downward, upward, or parallel to the ground. A gyroscope can be a component of the orientation sensor 58. The orientation sensor 58 can generate the orientation signal in response to the orientation that is detected and communicate the orientation signal to the processor 40. The orientation of the consumer's head can indicate whether the consumer is viewing a lower shelf, an upper shelf, or a middle shelf.

The accelerometer 60 can be configured to generate an acceleration signal indicative of the motion of the consumer. The acceleration signal can be processed to assist in determining if the consumer has slowed or stopped, tending to indicate that the consumer is evaluating one or more products for purchase. The accelerometer 60 can be a sensor that is operable to detect the motion of the consumer wearing the head mountable unit 14. The accelerometer 60 can generate a signal based on the movement that is detected and communicate the signal to the processor 40. The motion that is detected can be the acceleration of the consumer and the processor 40 can derive the velocity of the consumer from the acceleration. Alternatively, the position detection server 12 can process the acceleration signal to derive the velocity and acceleration of the consumer in the retail store.

The accelerometer 60 and direction sensor 54 could be used to occasionally approximate the field of view perceived by the consumer between occurrences of real-time video monitoring with the cameras 42. Also, the accelerometer 60 and direction sensor 54 could be used to approximate the consumer's location in store between occurrences of determining the location in real-time, the determination based on the detection and assessment of a light source in a video signal.

The proximity sensor 62 can be operable to detect the presence of nearby objects without any physical contact. The proximity sensor 62 can apply an electromagnetic field or a beam of electromagnetic radiation such as infrared and assess changes in the field or in the return signal. Alternatively, the proximity sensor 62 can apply capacitive photoelectric principles or induction. The proximity sensor 62 can generate a proximity signal and communicate the proximity signal to the processor 40. The proximity sensor 62 can be useful in determining when a consumer has grasped and is inspecting a product.

The distance sensor 64 can be operable to detect a distance between an object and the head mountable unit 14. The distance sensor 64 can generate a distance signal and communicate the signal to the processor 40. The distance sensor 64 can apply a laser to determine distance. The direction of the laser can be aligned with the direction that the consumer is looking. The distance signal can be useful in determining the distance to an object such as a light source in the video signal generated by one of the cameras 42, which can be useful in determining the consumer's location in the retail store.

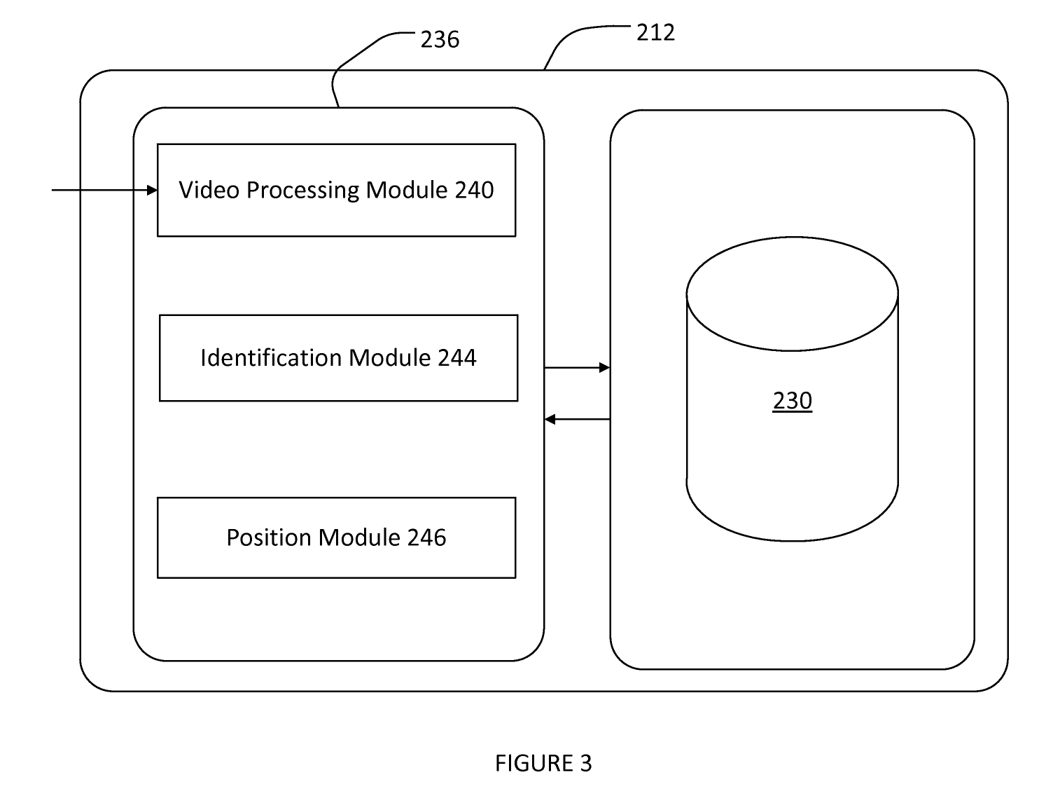

FIG. 3 is a block diagram illustrating a position detection server 212 according to some embodiments of the present disclosure. In the illustrated embodiment, the position detection server 212 can include a light source identification database 230. The position detection server 212 can also include a processing device 236 configured to include a video processing module 240, an identification module 244, and a position module 246.

Any combination of one or more computer-usable or computer-readable media may be utilized in various embodiments of the disclosure. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages.

The light source identification database 230 can include distinguishing characteristics associated with each light source positioned within the retail store. Distinguishing data can include the location of the light source, the frequency or frequency spectrums emitted by the light source, physical configuration of patterns of light-emitting structures of the light source, and pulsation pattern(s) associated with any pulsating light-emitting structures of the light source. The data in the light source identification database 230 can be organized based on one or more tables that may utilize one or more algorithms and/or indexes.

The light source identification database 230 can include in memory the location of each of the light sources positioned within the retail store. The location of each of the plurality of light sources can be defined in relation to store features such as aisles or store departments. The location of each of the plurality of light sources can also be defined in relation to a geometric grid covering the entire retail store in a fashion similar to a Cartesian coordinate system. The location of a light source stored in the light source identification database 230 can also include the direction that light is primarily directed from any light-emitting structures.

The light source identification database 230 can also include in memory the frequency spectrums associated with each light source. The frequency spectrum of a light source can include a dominant wavelength of the light source or a set of dominant wavelengths of the light source. The frequency spectrum defines the colors emitted by a light source. The color of light emitted by a light-emitting structure can be controlled by the construction of the light-emitting structure, such as the material properties (the energy bandgap) of a light emitting diode. The color of light emitted by a light-emitting structure can also be controlled by the placement of a color lens over the light-emitting structure. In some embodiments of the disclosure, a light source can emit light having one or more wavelengths in the visible spectrum and/or one or more wavelengths in the non-visible spectrum, such as in the infrared spectrum.

The light source identification database 230 can also include in memory the physical configuration of each light source. For example, a light source can include a single light-emitting structure. Alternatively, a light source in an embodiment of the present disclosure can include a plurality of light-emitting structures arranged in a pattern. The pattern of light-emitting structures can be detectable in the video signal and therefore the pattern can be stored in the light source identification database 230.

The light source identification database 230 can also include timing or pulsation patterns implemented by light sources positioned in the retail store. The pulsating pattern can be selected in response to the frame rate of the camera 42 or can be independent of the frame rate. The dependency of light pulsation on the frame rate of the camera 42 can be a harmonic dependency such that the light source appears in every “N” frames, where N is an integer.

The processing device 236 can communicate with the database 230 and receive one or more signals from the head mountable unit 14. The processing device 236 can include computer readable memory storing computer readable instructions and one or more processors executing the computer readable instructions.

The video processing module 240 can be operable to receive a video signal from the camera 42 of the head mountable unit 14. The video processing module 240 can also be operable to implement known video recognition/analysis techniques and algorithms to analyze the video signal received from the head mountable unit 14. For example, the video processing module 240 can analyze the video signal for the presence of a light source. If a light source is detected in the video signal, the video processing module 240 can attempt to determine the number and arrangement of light-emitting structures of the light source. The video processing module 240 can also detect the color(s) of light-emitting structures of the light source. Through the analysis of multiple frames of the video signal, the video processing module 240 can also detect any pulsation pattern of light-emitting structures of the light source.

The identification module 244 can be configured to identify the light source from among a plurality of light sources positioned in the retail store. Applying the data derived by the video processing module 240, the identification module 244 can access information stored in the light source identification database 230 and identify the light source from among a plurality of light sources positioned within the retail store.

The position module 246 can be operable to function cooperatively with the video processing module 240 and the identification module 244. The position module 246 receive the position of the light source from the identification module 244 and can further analyze the video signal to determine the location of the consumer in the retail store. The position of the light source within the retail store can be a point of reference. The position of the light source within the video signal can indicate the position of the consumer relative to the light source. In addition, the data in the video signal can indicate the direction that the consumer is looking.

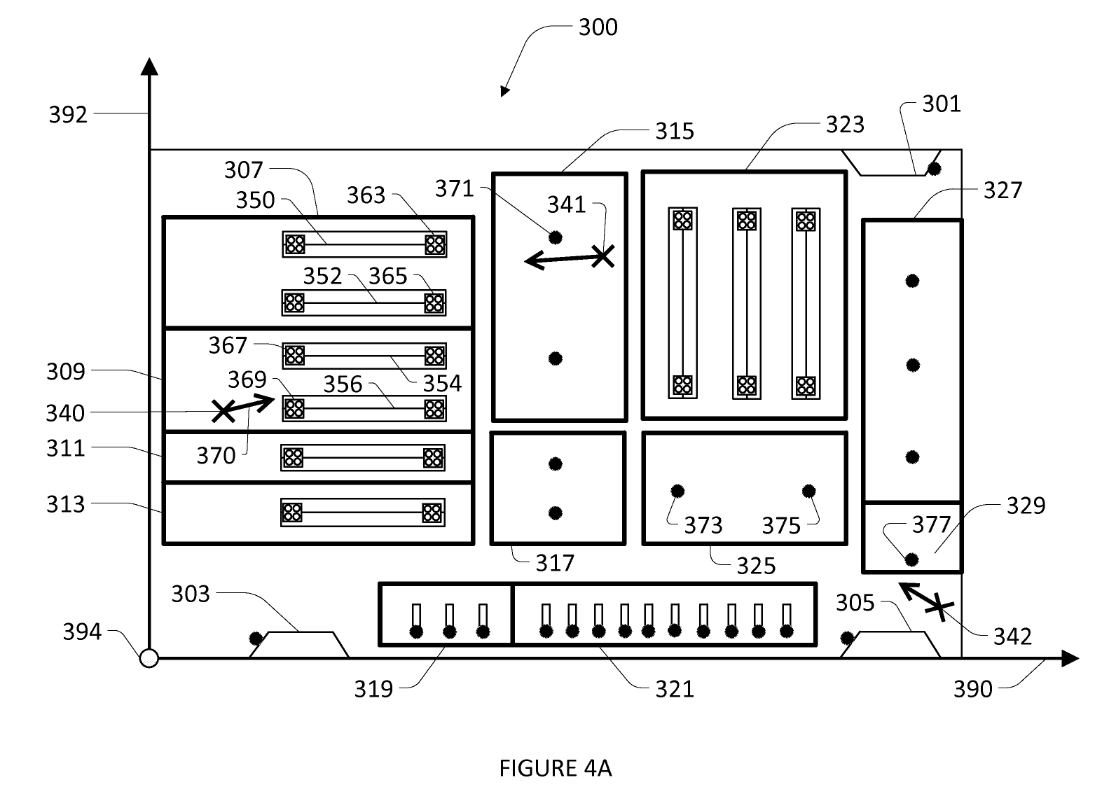

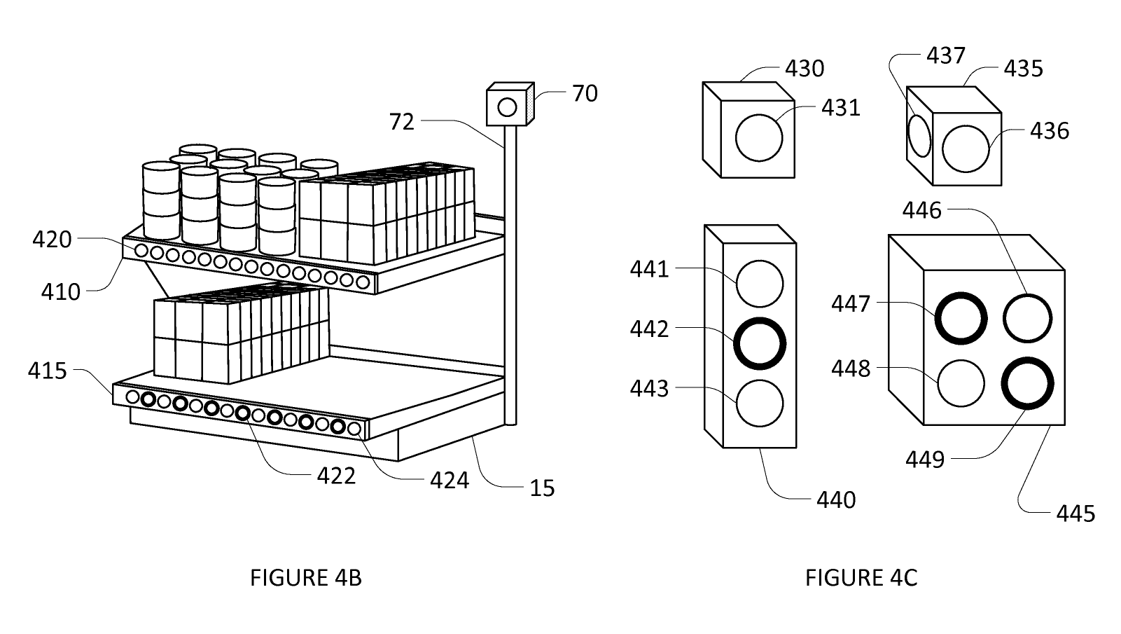

FIG. 4A illustrates a retail store map 300. The map 300 includes entrances 301, 303, 305, and store departments 307, 309, 311, 313, 315, 317, 323, 325, 327, 329. The map 300 also displays a consumer service area 319, checkout counter area 321, and aisles 350, 352, 354, 356. It is noted that not all aisles are annotated to enhance the clarity of FIG. 4A but are illustrated similarly. Light sources 371, 373,375, 377 can include a single light-emitting structure. It is noted that in FIG. 4A less than all of the light sources having a single light-emitting structure are annotated in order to enhance the clarity of FIG. 4A but are illustrated identically. Light sources 363, 365, 367, 369 can each include a plurality of light-emitting structures. It is noted that in FIG. 4A less than all of the light sources having a plurality of light-emitting structures are annotated to enhance the clarity of FIG. 4A but are illustrated identically.

Consumers shopping in the retail store are referenced at 340, 341, and 342. A horizontal axis 390 is displayed extending along one edge of the map 300 and a vertical axis 392 is displayed extending along another edge of the map 300. An origin 394 of a Cartesian style coordinate system is defined at the intersection of the axes 390 and 392.

In some embodiments of the present disclosure, consumers 340, 341, and 342 each possess a head mountable unit 14 which can transmit a video signal to the position detection server 212. The position detection server 212 can receive the video signal from the head mountable unit 14 possessed by consumer 340. The video processing module 240 can detect light sources 367 and 369 in the video signal and determine distinguishing data associated with each light source 367 and 369, such as frequency spectrums, physical configuration, and pulsation pattern(s). The identification module 244 can apply this data in accessing the light source identification database 230. The identification module 244 can identify the light sources 367 and 369 from the data in the light source identification database 230 and can thus identify the positions of the light sources 367 and 369 in the retail store.

The position module 246 can receive the position of the light sources 367 and 369 from the identification module 244 and can further analyze the video signal to determine the location of the consumer in the retail store. The positions of the light sources 367 and 369 within the retail store can indicate the position of the consumer as being in an area proximate to the light sources 367 and 369. The positions and appearances of the light sources 367 and 369 within frames of the video signal can further define the position of the consumer. For example, since both light sources 367 and 369 are visible, the position module 246 can determine the direction that the consumer is looking. This direction is referenced in FIG. 4A at 370. Further, the positions of the light sources 367 and 369 relative to each other can reveal the position of the consumer through triangulation and/or trigonometric calculations. The position module 246 can determine the position of the consumer and the direction that the consumer is looking with respect to the axes 390 and 392 or with respect to features in the retail store.

FIGS. 4B and 4C illustrate various configurations of light sources that can be applied in some embodiments of the present disclosure. FIG. 4B illustrates a shelf 15 in a retail store. A first light source 70 supported by attaching structure 72 can be mounted on the shelf 15. A second light source 410 and a third light source 415 can also be mounted on the shelf 15. The second light source 410 can include a series of similarly-constructed light-emitting structures 420. The third light source 415 can include different light-emitting structures 422 and 424. The light-emitting structures 422 and 424 can emit different wavelengths and/or intensities, can have structural differences such as different lens or shapes, and/or can pulsate differently.

FIG. 4C illustrates a plurality of different light sources that can be applied in some embodiments of the present disclosure. Light source 431 can be a single light-emitting structure positioned within a housing 430. Light source 435 can include two light-emitting structures 436 and 437 directed in two planes that are orthogonal to one another. Light source 440 can include light-emitting structures 441, 442, 443. The light-emitting structures 441 and 443 can have emit light at a first frequency and the light-emitting structure 442 can emit light at a second predetermined frequency different than the first predetermined frequency. Light-emitting structures 441, 442, and 443 can share a timing pattern or can emit light under different timing patterns. Light source 445 can include light-emitting structures 447 and 449 emitting light at a first frequency, light-emitting structure 446 emitting light at a second frequency, and light-emitting structure 448 emitting light at a third frequency. Light-emitting structures 446, 447, 448, and 449 are shown disposed on the same plane for emitting light in the same primary direction. In some embodiments, each of the light-emitting structures 446, 447, 448, and 449 could be disposed in separate planes and positioned to emit light in a plurality of different directions.

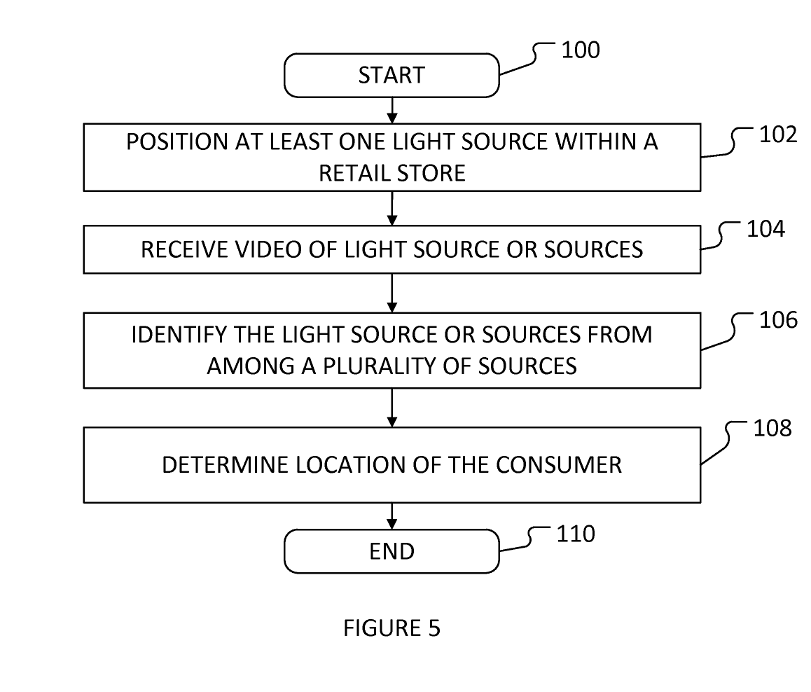

FIG. 5 is a flow chart illustrating a method that can be carried out in some embodiments of the present disclosure. The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The method as illustrated in FIG. 5 can be executed by a position detection server. The position detection server can be located at the retail store or can be remote from the retail store. The method starts at step 100. At step 102, at least one light source can be positioned within a retail store. At step 104, the video signal containing an image of the at least one light source can be received by the position detection server 212. At operation 106, the commerce serve can identify the light source from among a plurality of light sources positioned in the retail store. Operation 106 is optional, as embodiments of the present disclosure can be practiced with a single light source. At step 108, the position detection server can determine a location of the consumer within the retail store based on the video signal and the location of the light sources that were identified in the video signal. The exemplary method ends at step 110.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The above description of illustrated examples of the present disclosure, including what is described in the Abstract, are not intended to be exhaustive or to be limitation to the precise forms disclosed. While specific embodiments of, and examples for, the present disclosure are described herein for illustrative purposes, various equivalent modifications are possible without departing from the broader spirit and scope of the present disclosure. Indeed, it is appreciated that the specific example voltages, currents, frequencies, power range values, times, etc., are provided for explanation purposes and that other values may also be employed in other embodiments and examples in accordance with the teachings of the present disclosure.

What is claimed is:

1. A method comprising:
positioning at least one light source at a position in a retail store;
receiving, with a processing device of a position detection server, a video signal from an electronic device possessed by a consumer as the consumer shops in the retail store wherein at least one image frame of the video signal contains the at least one light source; and
determining, with the processing device, a location of the consumer within the retail store in response to said receiving step.

2. The method of claim 1 further comprising:
emitting, with the least one light source, light having a predetermined frequency.

3. The method of claim 1 wherein said positioning step further comprises:
positioning a light source having a plurality of light-emitting structures mounted together at the position in the retail store.

4. The method of claim 3 wherein said positioning step further comprises:
positioning a light source having a first light-emitting structure configured to emit light at a first frequency and a second light light-emitting structure configured to emit light at a second frequency wherein the first frequency is different from the second frequency.

5. The method of claim 1 wherein said determining step further comprises:
determining, with the processing device, a distance between the consumer and the position of the light source.

6. The method of claim 1 wherein said determining step further comprises:
determining, with the processing device, a direction the consumer is looking based on the video signal.

7. The method of claim 1 further comprising:
pulsating the at least one light source in a predetermined timing pattern.

8. A system comprising:
a position detection server having a processing device operable to receive a video signal from an augmented reality device possessed by a consumer as the consumer shops in a retail store wherein at least one image frame of the video signal contains at least one light source and the processing device includes:
a video processing module operable to receive the video signal and detect the at least one light source in the video signal and also detect at least one distinguishing characteristic of the light source;
an identification module operable to identify the at least one light source from among a plurality of light sources in the retail store in response to the at least one distinguishing characteristic of the light source; and
a position module operable to determine a location within the retail store of the consumer based on the identity of the at least one light source and based on the video signal received from the augmented reality device.

9. The system of claim 8 further comprising:
a pulsation module operable to drive the at least one light source on and off in a predetermined timing pattern.

10. The system of claim 8 wherein the position module is operable to determine a direction that the consumer is looking.

11. The system of claim 8 further comprising:
a light source identification database containing a location of each of the plurality of light sources within the retail store.

12. The system of claim 11 wherein said light source identification database contains the at least one distinguishing characteristic for each of the plurality of light sources and the at least one distinguishing characteristic is one of emitted frequency, configuration, and pulsation timing pattern.

13. A method comprising:
positioning a plurality of light sources at respective and spaced positions in a retail store;
receiving, with a processing device of a position detection server, a video signal from a head mountable unit possessed by a consumer as the consumer shops in the retail store wherein at least one image frame of the video signal contains one of the plurality light sources;
identifying, with the processing device, the light source in the video signal from among the plurality of light sources within the retail store; and
determining, with the processing device, a location of the consumer within the retail store in response to said identifying step.

14. The method of claim 13 further comprising:
storing, in a database, the positions of the plurality of light sources relative to one another within the retail store.

15. The method of claim 13 wherein said positioning step further comprises:
positioning light sources in the retail store that are configured differently with respect to one another.

16. The method of claim 15 wherein said positioning step further comprises:
positioning light sources in the retail store that include a different number of light-emitting structures with respect to one another.

17. The method of claim 15 wherein said positioning step further comprises:
positioning light sources in the retail store that include different patterns of multiple light-emitting structures with respect to one another.

18. The method of claim 13 wherein said positioning step further comprises:
positioning light sources in the retail store that emit light at different frequencies with respect to one another.

19. The method of claim 13 wherein said positioning step further comprises:
positioning light sources in the retail store that emit light at different pulsation time frequencies with respect to one another.

20. The method of claim 13 wherein said determining step further comprises:
determining, with the processing device, a direction that the consumer is looking within the retail store in response to the video signal received during said receiving step.
